(19) United States
(12) Patent Application Publication
(10) Pub. No.: US 2025/0128623 A1
(43) Pub. Date: Apr. 24, 2025

(54) RESERVATION DEVICE FOR ELECTRIFIED VEHICLE CHARGER

(71) Applicant: TOYOTA JIDOSHA KABUSHIKI KAISHA, Toyota-shi (JP)

(72) Inventors: Shin MURAO, Nisshin-shi (JP); Yoshihiro SAKAYANAGI, Mishima-shi (JP); Takeshi MATSUSAKA, Gamagori-shi (JP)

(73) Assignee: TOYOTA JIDOSHA KABUSHIKI KAISHA, Toyota-shi (JP)

(21) Appl. No.: 18/753,368

(22) Filed: Jun. 25, 2024

(30) Foreign Application Priority Data
Oct. 20, 2023 (JP) 2023-180678

(51) Int. Cl. B60L 53/30; G01C 21/34; G06Q 10/02

(52) U.S. Cl. CPC B60L 53/305; G01C 21/343; G06Q 10/02

(57) ABSTRACT

In the extraction process, the processor extracts the charging spots installed on the travel route to the destination of electrified vehicle as the candidate spots. In the tentative reservation setting process, the processor tentatively reserves a charging spot selected from among the candidate spots. In the time estimation process, the processor determines an estimated time to arrival at the provisionally reserved charging spot. When the estimated time to arrival is less than or equal to the predetermined reference time, the processor executes the reservation setting process. In this reservation setting process, the processor reserves a charger in an empty state among the chargers installed in the provisionally reserved charging spots. In this reservation setting process, the designated arrival time to the reserved charger is set for electrified vehicle.

### CROSS-REFERENCE TO RELATED APPLICATION

This application claims priority to Japanese Patent Application No. 2023-180678 filed on Oct. 20, 2023, incorporated herein by reference in its entirety.

### BACKGROUND

### 1. Technical Field

The present specification discloses reservation devices for electrified vehicle chargers.

### 2. Description of Related Art

For example, Japanese Unexamined Patent Application Publication No. 2023-41440 (JP 2023-41440 A) discloses a vehicle charging system. A charging reservation is set for a charging station. When the level of congestion of the reserved charging station is equal to or higher than a reference value, incentive information is sent to an electrified vehicle. The incentive information includes information about a reward that will be provided to the driver of the electrified vehicle. The driver can get the reward by performing high-efficiency driving with energy consumption efficiency of a reference value or more. Performing the high-efficiency driving with low power consumption can reduce the charging time at the charging station. This reduces congestion of the charging station.

For example, Japanese Unexamined Patent Application Publication No. 2014-32041 (JP 2014-32041 A) discloses a charger reservation device. In this charger reservation device, chargers at which an electrified vehicle will be able to arrive from a destination are tentatively selected. The charger reservation device then reselects chargers before the electrified vehicle travels from the destination to a charger. The chargers to be reselected are chosen from the chargers closer to the destination. That is, the chargers at which the electrified vehicle is more likely to arrive at are selected.

### SUMMARY

A charging reservation allows the user of an electrified vehicle to occupy the reserved charger for a certain period of time. The arrival time is set in order to prevent a decrease in operating rate of the charger. If the electrified vehicle does not arrive at the reserved charger by the set arrival time, the charging reservation will be cancelled.

This motivates the user of the electrified vehicle to give priority to arriving at the charger before the set arrival time in order to secure the charge reservation. Therefore, “side trips” are limited. For example, the user is discouraged to stop by and shop at a store on the route to the charger. In other words, reserving a charger restricts actions of the user of electrified vehicle.

The present specification discloses a reservation device for an electrified vehicle charger that can reduce a decrease in operating rate of chargers while reducing restrictions on actions of users of electrified vehicles.

A reservation device for an electrified vehicle charger disclosed in the present specification includes a processor.

The processor performs an extraction process, a tentative reservation setting process, a time estimation process, and a reservation setting process.
In the extraction process, the processor extracts, as candidate spots, charging spots that are located on a travel route to a destination of an electrified vehicle. At least one charger is installed in each of the charging spots.
In the tentative reservation setting process, the processor tentatively reserves the charging spot selected from the candidate spots.
In the time estimation process, the processor obtains an estimated time to arrival. The estimated time to arrival is a time required for the electrified vehicle to arrive at the tentatively reserved charging spot.
The processor performs the reservation setting process when the estimated time to arrival becomes equal to or less than a predetermined reference time. In the reservation setting process, the processor reserves an available charger out of the at least one charger installed in the tentatively reserved charging spot.
In the reservation setting process, a designated arrival time to the reserved charger is set for the electrified vehicle.

With the above configuration, the designated arrival time is set when the tentative reservation is switched to the reservation. This reduces time restrictions on the charger in the stage of the tentative reservation. The charging spot is merely selected at the time of the tentative reservation, and occupancy of the charger is avoided, which reduces a decrease in operating rate of the charger.

In the above configuration, the reservation device may further include a display. The display may be disposed in the electrified vehicle.

In the reservation setting process, when there is no available charger in the tentatively reserved charging spot, the processor may cause the display to display an unavailable reservation message. The processor may also cancel the tentative reservation.

With the above configuration, it is possible to tentatively reserve another charging spot when the reservation cannot be set.

When the electrified vehicle passes the reserved charger after the reservation setting process, the processor may cancel the reservation.

The above configuration eliminates the need for a manual operation to cancel the reservation.

In the above configuration, in the tentative reservation setting process, the processor may obtain an estimated arrival time at which the electrified vehicle arrives at the tentatively reserved charging spot.

When the reservation setting process is not performed even after the estimated arrival time passes, the processor may keep the tentative reservation.

With the above configuration, the tentative reservation will be kept even if the electrified vehicle does not arrive at the tentatively reserved charging spot at the estimated arrival time.

The reservation device for an electrified vehicle charger disclosed in the present specification can reduce a decrease in operating rate of chargers while reducing restrictions on actions of users of electrified vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a hardware configuration of an electrified vehicle charger;

FIG. 2 is a block diagram illustrating the function of an electrified vehicle charger;

FIG. 3 is a diagram illustrating a navigation screen;

FIG. 4 is a flowchart illustrating a provisional reservation setting process of a charger;

FIG. 5 is a diagram illustrating a selection screen of a tentative reservation spot;

FIG. 6 is a diagram exemplifying a screen at the time of determining a tentative reservation spot;

FIG. 7 is a flowchart illustrating the present reservation switching process;

FIG. 8 is a diagram illustrating a screen at the time of completion of the reservation;

FIG. 9 is a diagram exemplifying a screen when the present reservation is impossible;

FIG. 10 is a flow chart illustrating the reservation cancellation process; and

FIG. 11 is a diagram exemplifying a screen at the time of canceling the reservation.

### DETAILED DESCRIPTION OF EMBODIMENTS

### Overall Configuration

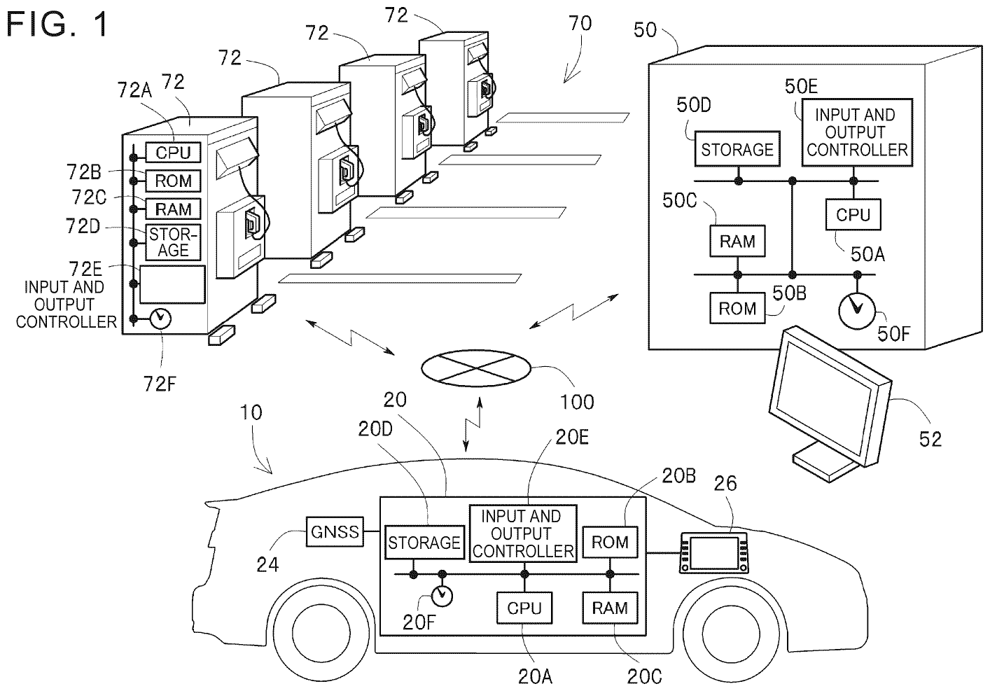

A configuration of an electrified vehicle charger will be described below with reference to the drawings. FIG. 1 illustrates an example of a configuration of an electrified vehicle charger. The reservation includes an electrified vehicle 10, a center server 50, and a charging spot 70. Electrified vehicle 10, the center server 50, and the charging spot 70 can communicate with each other using a communication unit such as the Internet 100.

Electrified vehicle 10 includes a AV-ECU 20, a positioning device 24, and a display 26. Electrified vehicle charger reservation device according to the present embodiment includes a AV-ECU 20, a positioning device 24, and a display 26. As described below, AV-ECU 20 is an electronic control unit. An in-vehicle audiovisual device such as the display 26 is controlled to be AV-ECU 20.

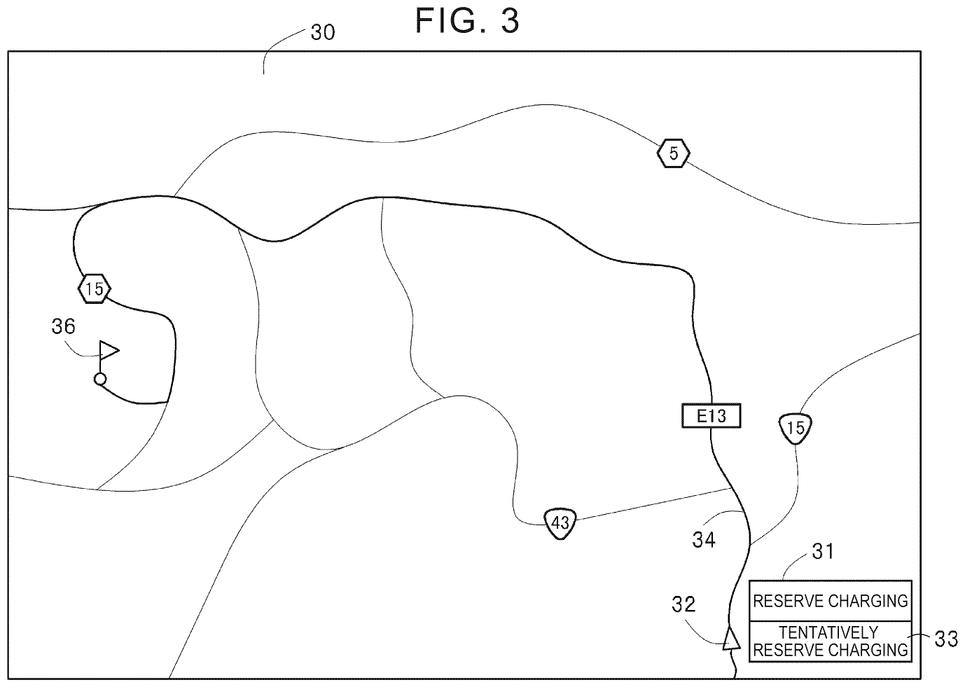

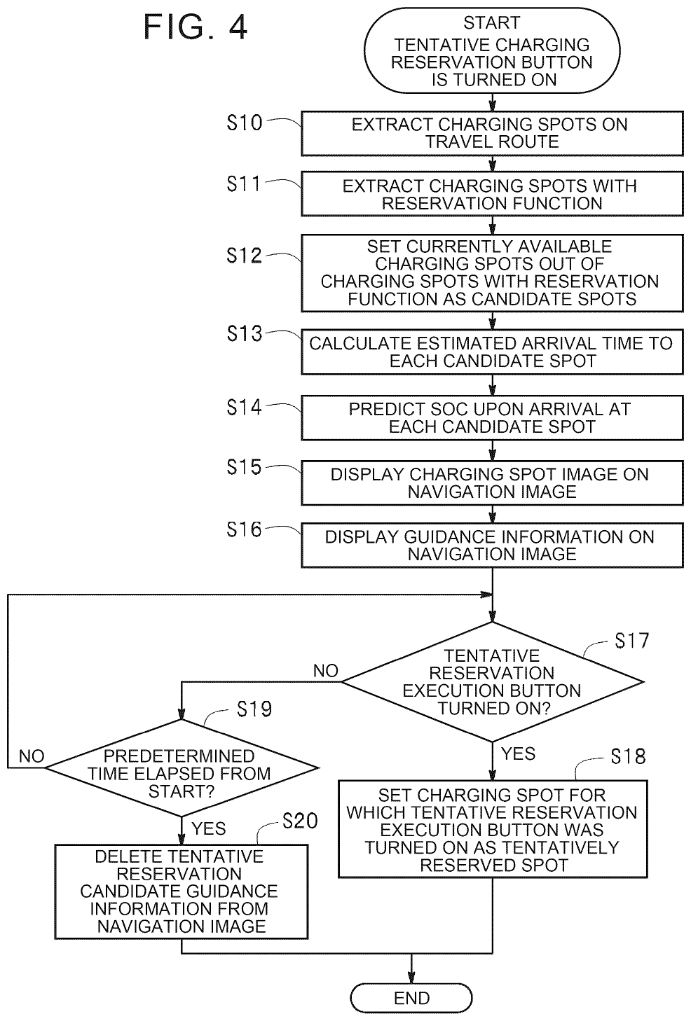

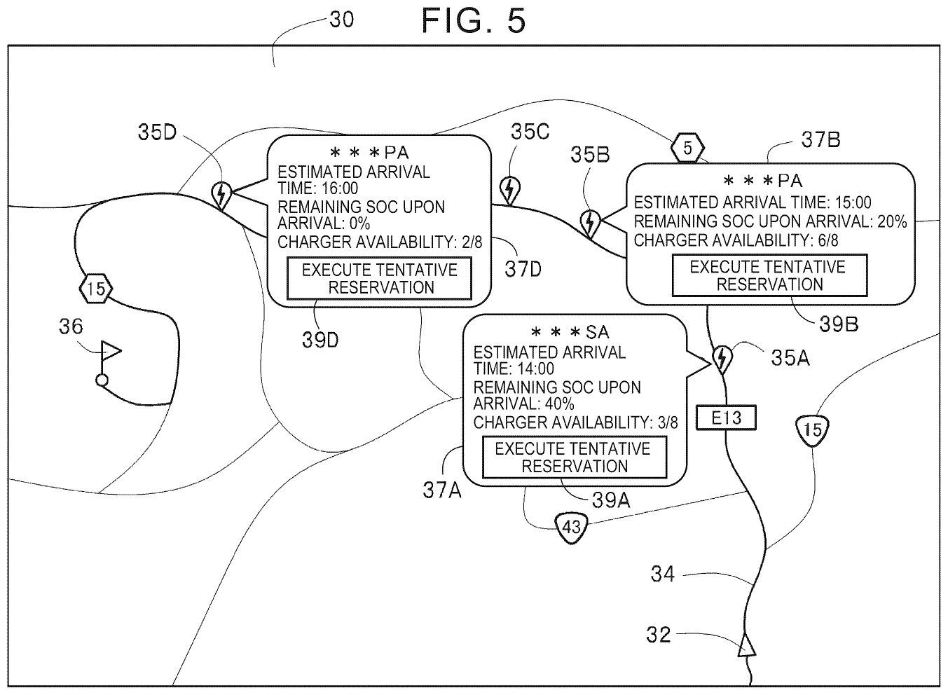

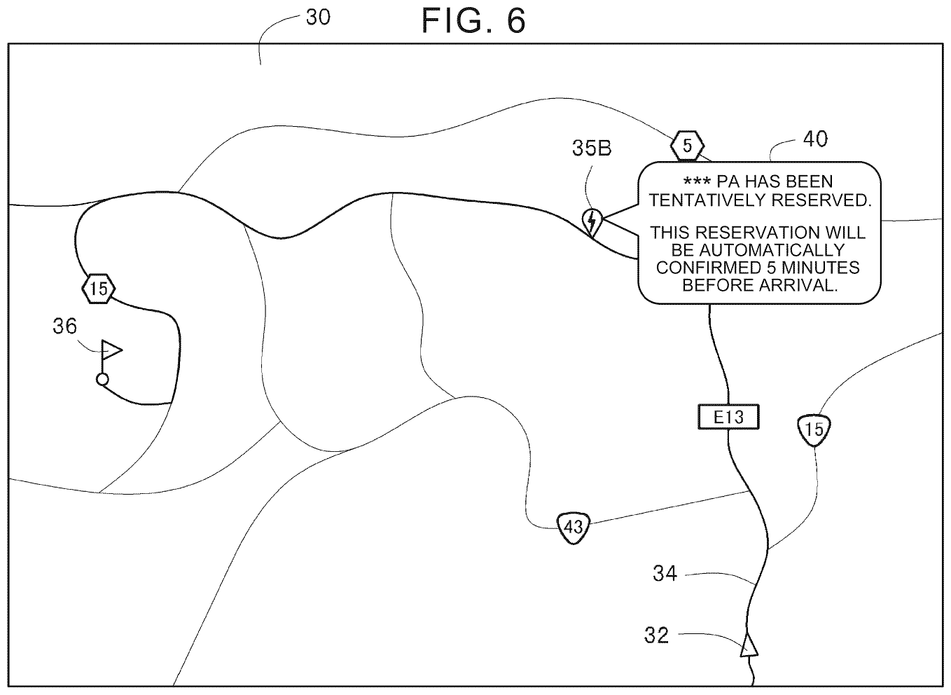

A navigation screen 30 as illustrated in FIG. 3 is displayed by the display 26. When the tentative charging reservation button 33 displayed on the navigation screen 30 is turned on, a tentative reservation setting process as illustrated in FIG. 4 is executed. Then, as illustrated in FIG. 5, a charging spot image 35B (tentative reservation spot) to be tentatively reserved is selected from the charging spot images 35A, 35B, 35C, 35D on the travel route 34 (see FIG. 6).

In the charging spot 70 (see FIG. 1) corresponding to the selected charging spot image 35B, any of the chargers 72 installed in the spot can be used by another person. That is, in the provisional reservation, the occupation of the charger 72 does not occur. Also, in the tentative reservation, the designated arrival time is not set. That is, even after the designated arrival time, the tentative reservation is kept.

Then, when electrified vehicle 10 reaches the vicinity of the charging spot 70 (tentative reservation spot) tentatively reserved, the tentative reservation is switched to the main reservation. In this reservation, any of the chargers 72 installed in the tentative reservation spots is occupied by electrified vehicle 10 for a predetermined period of time. In addition, the designated arrival time is set in electrified vehicle 10. If electrified vehicle 10 does not arrive at the reserved charger 72 by the designated arrival time, the reservation is cancelled.

### Charging Spot

Referring to FIG. 1, a charging spot 70 is a facility in which at least one charger 72 is installed. The charging spot 70 is installed in, for example, a service area or a parking area of an expressway. The charging spot 70 is also installed in an accommodation facility such as an automobile dealer or a hotel. The charging spot 70 is also installed in a commercial facility such as a large shopping mall.

The charger 72 is capable of rapid charging, for example. For example, in rapid charging, one charge is determined to be 30 minutes. In addition, the charger 72 includes a Central Processing Unit (CPU) 72A, Read Only Memory (ROM) 72B, Random Access Memory (RAM) 72C, a storage 72D, an input and output controller 72E, and a clock 72F as devices related to the reservation system of the charger 72.

CPU 72A is a central processing unit, also referred to as a processor. A RAM 72C is a volatile storage device that tentatively stores data that is in operation. ROM 72B is a data-readable storage device. The storage 72D is a storage device capable of writing and reading data. The storage 72D is composed of, for example, Hard Disk Drive (HDD) or Solid State Drive (SSD).

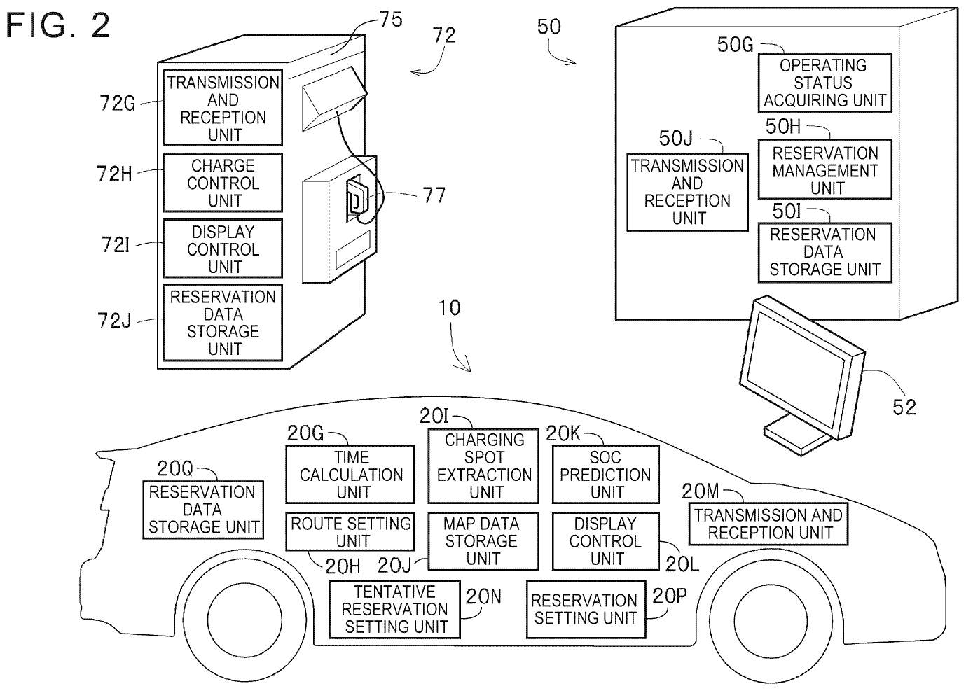

When CPU 72A (processor) executes a program stored in ROM 72B or the storage 72D, the charger 72 includes a processor and a storage unit as illustrated in FIG. 2. That is, the charger 72 includes a transmission/reception unit 72G, a charge control unit 72H, and a display control unit 72I. The charger 72 includes a reservation data storage unit 72J.

The transmission and reception unit 72G transmits and receives data to and from the center server 50 and electrified vehicle 10 to be charged. The charge control unit 72H performs power supply control at the time of rapid charge, for example. In the reservation period, the charge control unit 72H requests the reserved user to authenticate. The charge control unit 72H stops the power supply until the authenticating process is completed.

The display control unit 72I controls the display unit 75 of the charger 72. For example, the display control unit 72I refers to the data in the reservation period from the reservation data storage unit 72J. In the reserved period, the display control unit 72I causes the display unit 75 to display a message “Reserved”. This message is displayed in red, for example.

In addition, in a normal time period other than the reserved time period, the display control unit 72I refers to the power supply state (use state) by the charge control unit 72H. For example, when the charger 72 is in use, the display control unit 72I causes the display unit 75 to display a message “Occupied”. This message is displayed in red, for example.

When the charger 72 is empty, the display control unit 72I causes the display unit 75 to display a message “Available”. This message is displayed in green, for example. Note that the “empty state” refers to a state in which the charger 72 is not in the use state and is out of the reserved time.

The reservation data storage unit 72J stores reservation data for the charger 72. A reservation command is transmitted from the center server 50 to the charger 72. The reservation command includes a reservation period and an identifier (ID) of the appointer. The reservation data storage unit 72J stores data included in the reserved command.

### Center Server

Referring to FIG. 1, the center server 50 is capable of communicating with a plurality of chargers 72 and a plurality of electrified vehicle 10. The center server 50 centrally manages, for example, data related to a charging service. The center server 50 is a computer and is connected to the display unit 52. The center server 50 includes a CPU 50A, ROM 50B, RAM 50C, a storage 50D, an input and output controller 50E, and a clock 50F. The functions and the like of the devices are the same as those of CPU 72A, ROM 72B, RAM 72C, the storage 72D, the input and output controllers 72E, and the clock 72F of the charger 72. Therefore, the description will be omitted below.

When a CPU 50A (processor) executes a program stored in a ROM 50B or a storage 50D, the center server 50 includes a processor and a storage unit as illustrated in FIG. 2. That is, the center server 50 includes an operation status acquiring unit 50G, a reservation management unit 50H, and a transmitting and receiving unit 50J. In addition, the center server 50 includes a reservation data storage unit 50I.

The center server 50 manages a plurality of charging spots 70. The operation status acquiring unit 50G acquires the operation status of the plurality of chargers 72 managed. For example, during use, the operation state data such as the reserved time period and the free state is sent from the plurality of chargers 72 to the operation status acquiring unit 50G.

The reservation management unit 50H arranges the reservation of the charger 72. Details of the arrangement of the reservation will be described later. The reservation data storage unit 50I stores the reservation data set for the chargers 72. In addition, the reservation data storage unit 50I may store tentative reserved data set for the respective charging spots 70. That is, the provisional reservation status for each charging spot 70 is aggregated in the center server 50. The tentative reservation reflects the charging demand, and the tentative reservation data is used as a determination material when selecting the charging spot 70 for adding the charger 72.

### Electrified Vehicle

Referring to FIG. 1, an electrified vehicle 10 is a motor vehicle using a rotary electric machine (not shown) as a driving source. A battery (not shown), which is a power source of the rotary electric machine, is mounted on electrified vehicle 10. For example, electrified vehicle 10 is battery electric vehicle (BEV) or plug-in hybrid electric vehicle (PHEV).

Electrified vehicle 10 includes a power supply port (not shown) for external power supply. When the connector 77 (see FIG. 2) of the charger 72 is inserted into the power supply port, the battery is charged.

Electrified vehicle 10 includes a AV-ECU 20, a positioning device 24, and a display 26 as equipment related to the charger 72. AV-ECU 20, the positioning device 24, and the display 26 constitute a reservation device for an electrified vehicle charger according to the present embodiment.

The positioning device 24 acquires the position of electrified vehicle 10. The positioning device 24 is, for example, a Global Navigation Satellite System receiver. The positioning device 24 acquires, for example, latitude and longitude of electrified vehicle 10. The position of electrified vehicle 10 acquired by the positioning device 24 is transmitted to AV-ECU 20.

The display 26 is, for example, a touch panel display. That is, in the display 26, a transparent electrode layer (input portion) is stacked on a display (display portion). For example, the display 26 is disposed on an instrument panel (not shown) of electrified vehicle 10.

AV-ECU 20 controls audio visual equipment mounted on electrified vehicle 10. AV-ECU 20 is composed of a computer. As the hardware configuration, AV-ECU 20 includes a CPU 20A, ROM 20B, RAM 20C, a storage 20D, an input and output controller 20E, and a clock 20F. The functions of the devices are the same as those of CPU 72A, ROM 72B, RAM 72C, the storage 72D, the input and output controllers 72E, and the clock 72F of the charger 72. Therefore, the description will be omitted below.

When a CPU 20A (processor) executes a program stored in a ROM 20B or a storage 20D, AV-ECU 20 includes a processor and a storage unit as illustrated in FIG. 2. That is, AV-ECU 20 includes a time calculation unit 20G, a route setting unit 20H, and a charging spot extraction unit 20I. AV-ECU 20 further includes a SOC predicting unit 20K, a display control unit 20L, a transmitting/receiving unit 20M, a tentative reservation setting unit 20N, and a main reservation setting unit 20P. In addition, AV-ECU 20 includes a map data storage unit 20J and a reserved data storage unit 20Q. Specific processing contents of these processing units and storage units will be described later.

### Navigation Screen

The display control unit 20L causes the display 26 to display the navigation screen 30 as illustrated in FIG. 3. A map screen is displayed on the navigation screen 30. The map screen includes an own-vehicle mark 32, a destination mark 36, and a travel route 34.

When the navigation screen 30 is generated, the route setting unit 20H acquires the vehicle position from the positioning device 24. Further, a destination is input from the display 26 which is a touch panel display. The route setting unit 20H acquires map data including the vehicle position and the destination from the map data storage unit 20J. Further, the route setting unit 20H acquires traffic data from external servers such as traffic centers (not shown). The traffic information includes information such as traffic jam information and traffic restriction. The route setting unit 20H creates the travel route 34 from the vehicle position to the destination based on the traffic data. The display control unit 20L causes the display 26 to display the map images including the vehicle position and the destination. Further, the display control unit 20L causes the own-vehicle mark 32, the travel route 34, and the destination mark 36 to be superimposed on the map images.

Further, the display control unit 20L causes the images of the charge main reservation button 31 and the tentative charging reservation button 33 to be superimposed and displayed on the navigation screen 30.

### Preliminary Reservation Processing

When the tentative charging reservation button 33 is turned on by a user (e.g., a driver) of electrified vehicle 10, the tentative charging reservation setting process illustrated in FIG. 4 is executed. This processing is performed by a CPU 20A (processor) of AV-ECU 20.

Referring to FIG. 2, the charging spot extraction unit 20I performs an extraction process (S10, S11, S12) of the charging spot 70. The charging spot extraction unit 20I refers to the map data stored in the map data storage unit 20J. Then, the charging spot extraction unit 20I extracts the charging spots 70 installed on the travel route 34 (see FIG. 3) based on the map data (S10).

Next, the charging spot extraction unit 20I extracts a charging spot 70 having a reserved function from the extracted charging spots 70 (S11). For example, the reservation management unit 50H of the center server 50 and the charging spot extraction unit 20I communicate with each other. Then, the charging spot extraction unit 20I extracts the charging spot 70 registered in the center server 50.

Further, the charging spot extraction unit 20I extracts a charging spot 70 having an empty charger 72 at the present time point (extraction process time point) among the charging spots 70 having a reserved function (S12). The charging spots 70 extracted by S12 are also referred to as candidate spots in the following as appropriate.

For example, the charging spot extraction unit 20I extracts candidate spots via the operation status acquiring unit 50G of the center server 50. As described above, the empty state charger 72 refers to a state in which the charger 72 is not in the use state and is out of the reserved time.

Note that, even when there is no empty charger 72 in the charging spot 70 at the time of the tentative reservation, there is a case where the charger 72 changes from the use state to the empty state in the subsequent switching stage of the main reservation. Assuming such cases, S12 extraction process may be omitted. That is, all the charging spots 70 extracted by S11 may be the candidate spots.

Next, the time calculation unit 20G calculates an estimated arrival time (S13). The expected time at which electrified vehicle 10 arrives at the respective candidate spots is the estimated arrival time. In calculating the estimated arrival time, for example, it is assumed that electrified vehicle 10 travels without deviating from the travel route 34. In addition, the estimated arrival time is calculated in consideration of the congestion information and the speed limit of the travel route 34.

Next, SOC predictor 20K estimates the remaining SOC when electrified vehicle 10 arrives at the candidate spots (S14). For example, SOC predictor 20K calculates SOC of the current battery (not shown). Further, SOC predicting unit 20K estimate the amount of power consumed before arrival at each candidate spot in view of the amount of electric power consumed by the air conditioner and the amount of electric power consumed by the rotary electric machine. The remaining SOC is calculated based on the estimated power consumed.

Further, the display control unit 20L causes the display 26 to display the images of the charging spots extracted by S10 (S15). That is, the positions of all the charging spots 70 installed on the travel route 34 are displayed on the navigation screen 30. For example, all the charging spots 70 on the travel route 34 are extracted by S10 process. Referring to FIG. 5, all the charging spots 70 extracted by S10 are displayed as charging spot images 35A, 35B, 35C, 35D on the navigation screen 30.

Next, the display control unit 20L displays the guidance images 37 for the candidate spots (S16). For example, in FIG. 5, the charging spot images 35A, 35B, 35D correspond to the candidate spots. Guidance images 37A, 37B, 37D are displayed in the vicinity of the charging spot images 35A, 35B, 35D.

The guidance images 37A, 37B, 37D display the names of the respective charging spots 70, the estimated arrival times, the remaining SOC at the time of arrival, and the free state of the charger 72. In particular, the remaining SOCs in the candidate spots are displayed at the time of the tentative reservation. When the user of electrified vehicle 10 selects the charging spots 70 to be tentatively reserved, the remaining SOC is used as a determinant.

In the guidance images 37A, 37B, 37D, images of the tentative reservation execution buttons 39A, 39B, 39D are also superimposed and displayed. First, the tentative reservation setting unit 20N determines whether or not any of the tentative reservation execution buttons 39A, 39B, 39D has been turned on (S17). When neither of the buttons is turned on, the tentative reservation setting unit 20N refers to the clock 20F.

Then, the tentative reservation setting unit 20N determines whether or not a predetermined period of time has elapsed since the tentative charging reservation button 33 (see FIG. 3) was turned on (S19). The predetermined time is set to, for example, 5 minutes. When the predetermined period has elapsed, the display control unit 20L deletes the images of the guidance images 37A, 37B, 37D and the tentative reservation execution buttons 39A, 39B, 39D from the navigation screen 30 (S20). A screen (initial screen) of FIG. 3 is displayed on the navigation screen 30. On the other hand, in S19, when the tentative charging reservation button 33 (see FIG. 3) has been turned on and has not yet reached the predetermined period, the process returns to S17.

In S17, any of the tentative reservation execution buttons 39A, 39B, 39D is turned on by the user of electrified vehicle 10. The tentative reservation setting unit 20N sets the charging spot 70 corresponding to the turned-on operation, that is, the selected tentative reservation execution button 39A, 39B, 39D, to the provisional reservation spot (S18). This setting process is also called a tentative reservation setting process. The display control unit 20L causes the tentative reservation completion message 40 illustrated in FIG. 6 to be displayed on the navigation screen 30.

For example, in the present embodiment, the charging spot 70 is a target of tentative reservation. That is, the charger 72 is not subject to tentative reservation. Therefore, in the tentative reservation, the occupation of the charger 72 is not performed as in the case of the reserved charging. That is, any of the chargers 72 installed in the tentatively reserved charging spot 70 is not restricted by the provisional reservation. In other words, any of the chargers 72 installed in the tentatively reserved charging spot 70 can be used by others.

As described above, the tentative reservation does not affect the use state of the charging spot 70. From this point of view, the tentative reservation can be referred to as a kind of timer function for AV-ECU 20 to perform the setting process of the present reservation. Therefore, the tentative reservation data of the charging spots 70 may be stored only in electrified vehicle 10 reservation data storage unit 20Q.

Alternatively, the tentative reservation data may be transmitted to the center server 50. The tentative reservation reflects the charging demand of each charging spot 70. As a result, tentative reservation data is accumulated in the center server 50 as a determination material for selecting the charging spot 70 to which the charger 72 is to be added.

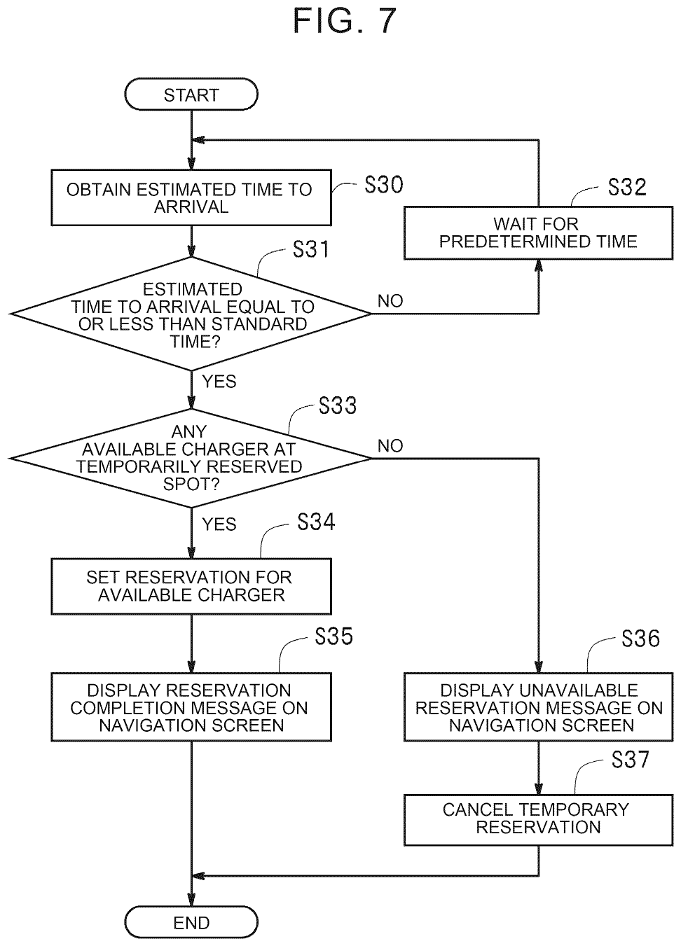

Further, in the tentative reservation setting process of FIG. 4, the estimated arrival time is calculated in S13. When electrified vehicle 10 has not arrived at the tentatively reserved charging spot 70 even at the expected arrival time, the tentative reservation setting unit 20N keeps the tentative reservation. In other words, even after the estimated arrival time, the present reservation setting process (S34 in FIG. 7) may not be executed. Even in such a case, the tentative reservation is kept.

As described above, the tentative reservation does not directly affect the operation of the charger 72. Further, as will be described later, when electrified vehicle 10 approaches the provisionally reserved charging spots 70, switching from the provisional reservation to the main reservation is executed. Based on such a process, the expected arrival time is only a guide. Therefore, even if the expected arrival time is exceeded, the tentative reservation is kept.

### Switching to Reservation Process

FIG. 7 illustrates a process of switching from a tentative reservation to a main reservation. When any one of the charging spots 70 is tentatively reserved, the time calculation unit 20G executes a time estimation process (S30). That is, the time calculation unit 20G obtains the time (estimated time to arrival) required for electrified vehicle 10 to arrive at the provisional reserved spot. That is, how long electrified vehicle 10 will arrive at the provisional reserved spot is calculated. For example, in S13 of FIG. 4, the time calculation unit 20G calculates the estimated time to arrival in the same manner as the estimated arrival time. Further, the time calculation unit 20G determines whether or not the estimated time to arrival is equal to or less than a predetermined reference time (S31). For example, the reference time is determined to be 5 minutes.

If the estimated time to arrival exceeds the reference time, electrified vehicle 10 is still far from the provisional reserved spot. In this case, the state of the tentative reservation is kept. Further, the time calculation unit 20G waits for a predetermined time (S32), and then executes S30 again.

In S31, when the estimated time to arrival is equal to or less than the reference time, the reservation setting unit 20P determines whether or not there is an available charger 72 in the tentative reservation spot (S33). For example, in this determination, the reservation setting unit 20P acquires the operation status of the chargers 72 from the operation status acquiring unit 50G of the center server 50.

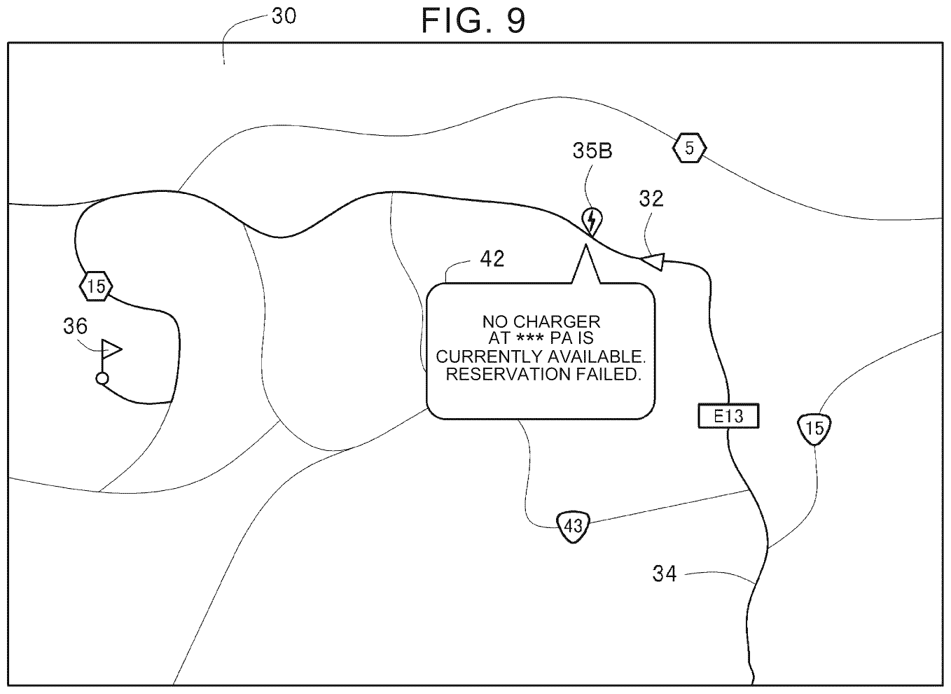

If there is no empty charger 72 in the tentative reservation spot, the display control unit 20L causes the unavailable reservation message 42 to be displayed on the navigation screen 30 as illustrated in FIG. 9 (S36). Further, the tentative reservation setting unit 20N cancels the tentative reservation (S37).

The unavailable reservation message 42 informs a user (e.g., a driver) of electrified vehicle 10 that the reservation cannot be made. In this instance, electrified vehicle 10 goes to the provisional reservation spot without reservation. Then, it waits at the tentative reservation spot until the charger 72 is empty. Alternatively, another charging spot 70 is tentatively reserved.

In S33, when there is an empty charger 72 in the provisional reservation spot, the reservation setting unit 20P sets the charger 72 as the provisional reservation (S34). This setting process is also referred to as the present reservation setting process.

For example, the reservation setting unit 20P transmits the reservation command to the center server 50. This reservation command includes the identification symbol of the charger 72 to be the target of the reservation, the identification symbol of electrified vehicle 10, and the data of the reservation period.

In short, this reservation refers to a setting that prevents others from using the charger 72 until electrified vehicle 10 arrives at the charger 72. For example, in S30, the reference time to be compared with the estimated time to arrival is set to 5 minutes. The time obtained by adding some margin to this is set as the reservation time zone. For example, the reserved time period is set such that the time at the time of S34 process is set as a starting point, and the end point is 10 minutes after the start point.

The reservation management unit 50H of the center server 50 receives the reservation command. In response to this, the reservation management unit 50H transmits this reservation command to the target charger 72. As a result, the use of the charger 72 by another person is suppressed until electrified vehicle 10 reaches the charger 72 that has been reserved.

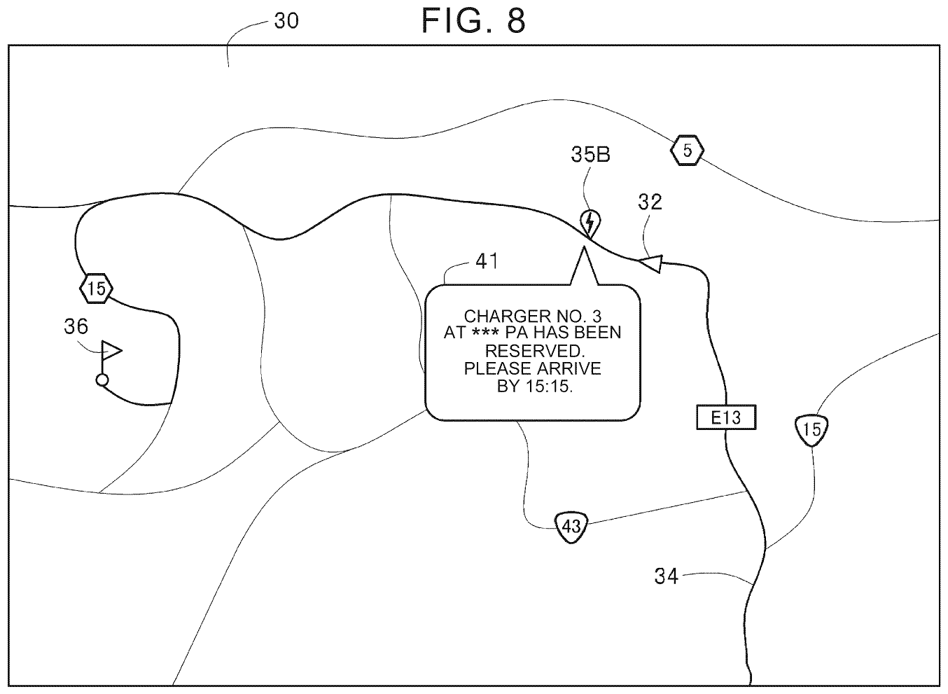

After the reservation is confirmed, the display control unit 20L causes the navigation screen 30 to display the reservation completion message screen 41 as illustrated in FIG. 8 (S35). On the reservation completion message screen 41, the designated arrival time is displayed.

As described above, in the present reservation, the designated arrival time is determined for electrified vehicle 10. If electrified vehicle 10 does not arrive at the reserved charger 72 by the designated arrival time, the reservation is cancelled. The designated arrival time is, for example, an end point time of the reservation time zone.

### Automatic Cancellation of This Reservation

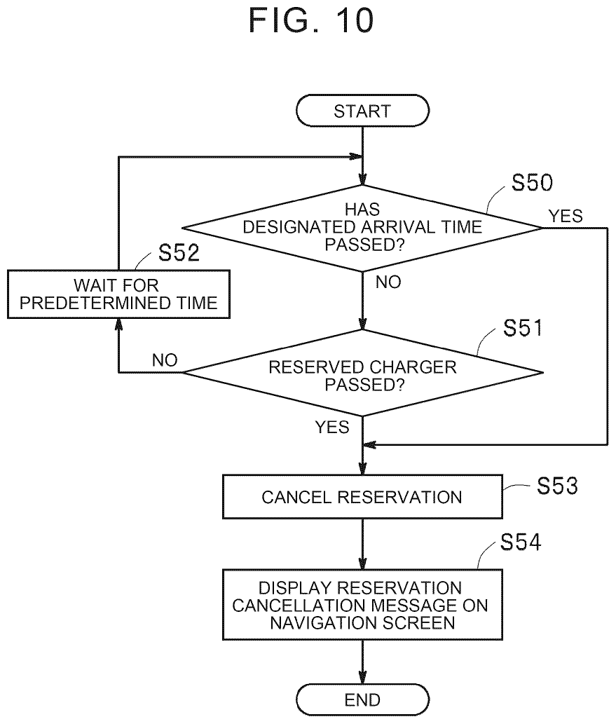

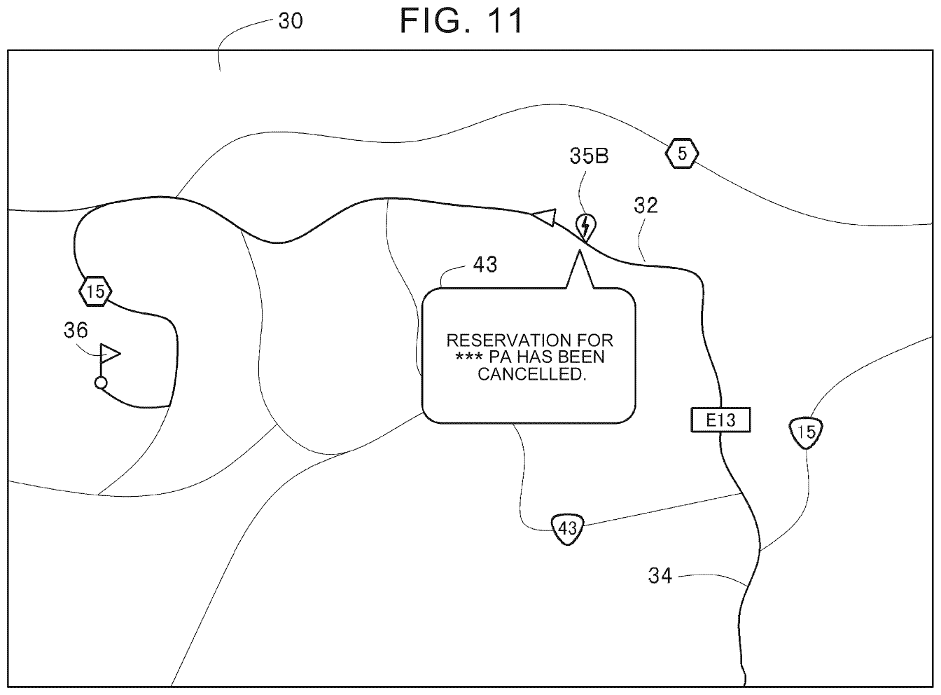

FIG. 10 illustrates the cancellation process of this reservation. This cancellation process is performed until electrified vehicle 10 arrives at the reserved charger 72. The time calculation unit 20G refers to the clock 20F (see FIG. 1) and determines whether or not the present time has passed the designated arrival time (S50). When the present time has passed the designated arrival time, the reservation setting unit 20P cancels the reservation (S53). Further, as illustrated in FIG. 11, the display control unit 20L causes the navigation screen 30 to superimpose the reservation cancellation message screen 43 (S54).

Returning to S50, if the present time has not passed the designated arrival time, the reservation setting unit 20P determines whether or not electrified vehicle 10 has passed through the charger 72 reserved (S51). For example, the reservation setting unit 20P compares the position information of the reserved charger 72 with the position information of electrified vehicle 10, and determines that electrified vehicle 10 passes through the reserved charger 72 when the distance between the two gradually increases. For example, when the distance between the two is gradually increased and the distance reaches 3 km, the reservation setting unit 20P determines that electrified vehicle 10 has passed through the charger 72 reserved.

If electrified vehicle 10 has not passed through the reserved charger, it is returned to S50 after a predetermined period of S52. On the other hand, when it is determined in S51 that electrified vehicle 10 has passed through the charger 72 that has been reserved, the reservation setting unit 20P cancels the reservation (S53). Further, as illustrated in FIG. 11, the display control unit 20L causes the navigation screen 30 to superimpose the reservation cancellation message screen 43 (S54).

A reservation device for an electrified vehicle charger according to another embodiment of the present disclosure

In the above-described embodiment, AV-ECU 20, the positioning device 24, and the display 26 mounted on electrified vehicle 10 constitute a reservation device for electrified vehicle charger. However, the reservation device is not limited to such a configuration.

For example, in place of AV-ECU 20, the positioning device 24, and the display 26, a portable terminal (smart phone) possessed by electrified vehicle 10 drivers constitutes a reservation device for electrified vehicle charger. Alternatively, as an alternative to AV-ECU 20, the center server 50 may be included in the reservation device.

What is claimed is:

1. A reservation device for an electrified vehicle charger, the reservation device comprising a processor, wherein
the processor is configured to perform
an extraction process of extracting, as candidate spots, charging spots that are located on a travel route to a destination of an electrified vehicle and in which at least one charger is installed,
a tentative reservation setting process of tentatively reserve the charging spot selected from the candidate spots,
a time estimation process of obtaining an estimated time to arrival that is required for the electrified vehicle to arrive at the tentatively reserved charging spot, and
a reservation setting process of, when the estimated time to arrival becomes equal to or less than a predetermined reference time, reserve an available charger out of the at least one charger installed at the tentatively reserved charging spot, and
in the reservation setting process, a designated arrival time to the reserved charger is set for the electrified vehicle.

2. The reservation device according to claim 1, further comprising a display disposed in the electrified vehicle, wherein in the reservation setting process, when there is no available charger in the tentatively reserved charging spot, the processor causes the display to display an unavailable reservation message and cancels the tentative reservation.

3. The reservation device according to claim 1, wherein when the electrified vehicle passes the reserved charger after the reservation setting process, the processor cancels the reservation.

4. The reservation device according to claim 1, wherein:
in the tentative reservation setting process, the processor obtains an estimated arrival time at which the electrified vehicle arrives at the tentatively reserved charging spot; and
when the reservation setting process is not performed even after the estimated arrival time passes, the processor keeps the tentative reservation.
